(19) United States
(12) Patent Application Publication
(10) Pub. No.: US 2008/0008395 A1
(43) Pub. Date: Jan. 10, 2008

(54) Image compression based on union of DCT and wavelet transform

(76) Inventor: Xiteng Liu, Columbia, SC (US)

Correspondence Address: Xiteng Liu, 501 Pelham Dr Apt L-102, Columbia, SC, 29209, US

(21) Appl. No.: 11/768,535

(22) Filed: Jun. 26, 2007

Related U.S. Application Data
(60) Provisional application No. 60/767,549, filed on Jul. 6, 2006.

(51) Int. Cl. G06K 9/36; H04N 7/12

(52) U.S. Cl. 382/244; 375/240.19; 382/240; 375/E07.048; 375/E07.051; 375/E07.067

(57) ABSTRACT

A union of DCT (discrete cosine transform) and wavelet transform can generate a much sparser representation of the digital image signal than either of them alone. After the block-based DCT, the coefficients are rearranged into a number of frequency groups such that the coefficients locating at the same coordinate in all transform blocks are in one group. Then, one or more such groups are further decomposed by wavelet transform. After quantization, each frequency group is divided into squares. The squares are identified and encoded as either all-zero or not-all-zero. Inside those not-all-zero squares, the coefficients are encoded bit-plane by bit-plane in a 2-dimensional quaternary reaching pattern. Compared to existing peer systems, the compression performance is improved up to 30%, especially in high quality cases. For lossless compression, the image data is decomposed by a union of a reversible DCT approximant and a reversible wavelet transform. Besides, the coefficients are quantized by a remnant-preserved, partial quantization scheme. The lossless compression performance is improved about 20% against JPEG2000.

### FIELD OF THE INVENTION

The present invention relates to digital image data compression.

### BACKGROUND OF THE INVENTION

In existing digital image and video data compression systems, such as JPEG, JPEG2000, MPEG1, MPEG2, MPEG4 and H.264, single mathematical transform is used. Among them, JPEG, MPEG1, 2, 4 and H.264 adopt the discrete cosine transform (DCT) or an integer approximant to DCT (H.264). JPEG2000 adopts the discrete wavelet transform. In all existing DCT-based image/video coding systems, the transform coefficients within a transform block are scanned and encoded in the famous linear zigzag pattern. In JPEG2000, the wavelet coefficients within one code-block are scanned and encoded in a one-by-one, column-by-column pattern. However, image signals and video frame signals are 2-dimensional in nature. Besides, there is strong statistical dependency between the frequency contents of neighboring blocks of image signals. The linear scan patterns can not effectively exploit the 2-dimensionally distributed statistical dependency and hence severely reduce coding efficiency. To enhance compression performance, the DCT coefficients and wavelet coefficients should be scanned and encoded in a 2-dimensional pattern. The quaternary reaching method provides an ideal 2-dimensional scan pattern. It effectively exploits the dependency between the frequency contents of adjacent blocks. In wavelet-based coding systems, the wavelet coefficients are rearranged into subbands in a hierarchical pyramidal structure. This structure makes it reasonable for 2-dimensional to be applied. Similarly, in a DCT-based coding system, the DCT coefficients represent local frequency contents of image signals. The coefficient coordinates within a transform block correspond to certain frequencies. The coefficients in neighboring blocks represent the frequency contents of the image signal in those blocks. Therefore, the coefficients at the same coordinates in neighboring blocks have strong statistical dependency. This dependency can be efficiently exploited by the quaternary reaching method. In order to apply the 2-dimensional quaternary reaching method, the DCT coefficients need to be rearranged such that the coefficients in the same coordinate within all transform blocks are in one group. These groups of DCT coefficients may either be further decomposed by wavelet transform to decorrelate the dependency, or be directly scanned and encoded.

### SUMMARY OF THE INVENTION

To effectively exploit the statistical dependency between the local frequency contents of image signals and hence greatly improve image compression performance, one method and apparatus described in the present invention involves rearranging block-based DCT coefficients into a number of frequency groups and then decomposing one or more of those groups by wavelet transform. Initially, the original image data are partitioned into blocks, say, 4×4 or 8×8. The blocks of data are decomposed by DCT (Discrete Cosine Transform) or integer approximants to DCT or Hadamard transform. Afterward, the DCT coefficients are rearranged into a number of groups such that the coefficients locating at the same coordinate within all transform blocks are in one group. The number of groups is equal to the size of transform block. The coordinate of a coefficient within a group is the coordinate of the block (which the coefficient comes from) within the whole image domain. Then, one or more groups are decomposed by discrete wavelet transform. At least, the DC group, i.e. the group of coefficients at coordinate (0, 0), is decomposed further by wavelet transform.

To encode the transform coefficients, each group of coefficients is divided into squares. After quantization, the squares are identified and then encoded as either all-zero or not-all-zero by either quadtree coding or arithmetic coder in some pattern. The coefficients in not-all-zero squares are then encoded by bit-plane by bit-plane in quaternary reaching pattern, from the most significant bit-plane to the least significant one.

One method for lossless image compression described herein replaces DCT with a 4×4 unnormalized Hadamard transform implemented in lifting steps which is reversible. The transform coefficients are rearranged in frequency groups as above. Afterward, the DC group, or other groups of coefficients are further decomposed by a reversible integer wavelet transform.

One method for lossless image compression described herein encodes transform coefficients in two layers. After either the transform combination as above described or only a reversible wavelet transform, take a threshold T. The coefficients are encoded in two layers by three steps: (1). Encode all coefficients which are less than T in magnitude by arithmetic coder and reset them as zeroes; (2). Divide each frequency group of coefficients into smaller squares. The squares are identified and encoded as either all-zero or not-all-zero; (3). The coefficients in not-all-zero squares are encoded bit-plane by bit-plane in quaternary reaching pattern.

One method for accelerating the bit-plane coding process described herein tests and encodes the significance status of squares and coefficients at two consecutive bit-planes at one time. If a coefficient is found significant in the test, one bit is output to signify at which bit-plane, the higher or the lower, the coefficient begins to be significant.

### BRIEF DESCRIPTION OF THE DRAWINGS

The invention is described in greater detail hereinafter, by way of example only, through description of a preferred embodiment thereof and with reference to the accompanying drawings in which:

FIG. 1 is an illustration of the rearrangement operation on the DCT coefficients among 4 adjacent 2×2 blocks.

FIG. 2 illustrates the effect of the rearrangement operation, by comparing the distribution characteristics of nonnegative coefficients before rearrangement (a) and after the rearrangement operation (b).

### DETAILED DESCRIPTION OF THE PREFERRED EMBODIMENT

One apparatus and method for effectively exploiting the statistical dependency between local frequency contents of image signals and hence greatly improving compression performance in an image compression system is herein disclosed. In the following description, for the purpose of explanation, specific nomenclature and specific implementation details are set forth to provide a full understanding of the present invention. The details of the techniques are apparent for one skilled in the art to practice the present invention.

Frequencywise Rearrangement of DCT Coefficients

The block-based discrete cosine transform (DCT) or its integer approximant is extensively applied in image or video coding systems, including JPEG, MPEG1, MPEG2, MPEG4, H.263 and H.264. It helps to decompose the image data into DCT coefficients which reflects the local frequency contents of the image signal. In those systems, DCT coefficients are scanned and encoded in a linear zigzag patter. However, in nature, image signals are 2-dimensional and hence the local frequency contents are also 2-dimensional distributed. Also, there exists strong statistical dependency between the local frequency contents at the same frequencies, i.e., the coordinates within transform blocks. Therefore, it is necessary to scan and encode DCT coefficients in a 2-dimensional pattern such as the quaternary reaching pattern.

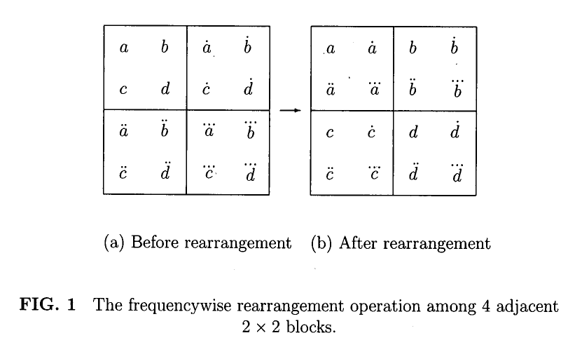

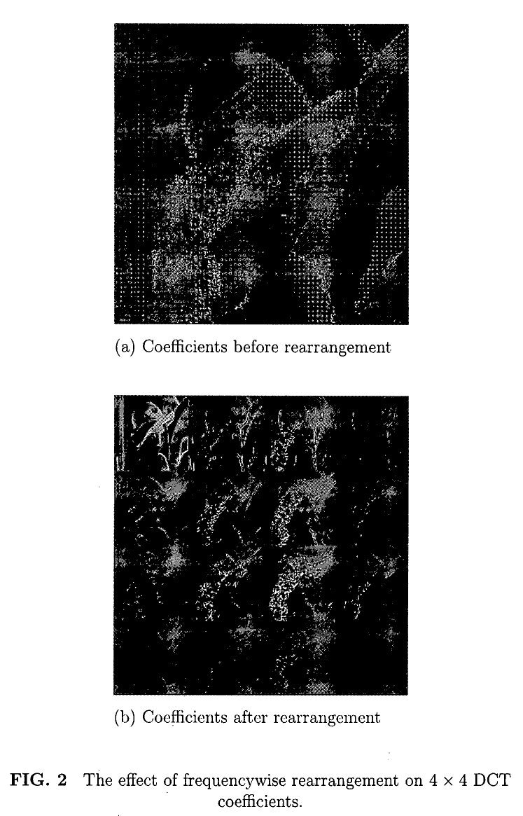

One method described herein is designed to 2-dimensionally scan DCT coefficients and effectively exploit the dependency between the local frequency contents. It rearranges the DCT coefficients at the same coordinate within different transform blocks into one group. Meanwhile, the coordinate of a coefficient within its group is the coordinate of its block (which the coefficient comes from) within the whole image domain. And, the coordinate of a group within the image domain is the same as the coordinate of its coefficients within their blocks. FIG. 1 illustrates the rearrangement operation on the coefficients inside 4 adjacent 2×2 blocks. Since the coordinates within a transform block correspond to frequencies in harmonic analysis, the rearrangement operation is essentially a frequencywise operation. FIG. 2 is an illustration of the effect of this frequencywise rearrangement operation on block-based DCT coefficients. It illustrates the distribution characteristic of nonnegative coefficients at each frequency.

Union of DCT and Wavelet Transform

After the frequencywise rearrangement, the DCT coefficients within one group reflect the local frequency contents of the image signal at a certain frequency (coordinate). There exists statistical correlation between the coefficients within one group. Wavelet transform may help to further decompose that correlation. At least, The DC group, i.e. the group of coefficients at the coordinate (0, 0) within all blocks, should be decomposed by wavelet transform. Under some circumstances, wavelet transform may also be applied inside other groups. After wavelet transform, the significance distribution of the transform coefficients may get to even sparser than without wavelet decomposition.

Exclude Zero Coefficients from Bit-plane Coding Process by A Value Map

In lossy compression, after quantization, uniform or visual weighting, a large number of coefficients are quantized to zero. In some frequency groups, especially the high frequency groups, the scenery sees that nonzero coefficients sparsely and 2-dimensionally disperse in a wide tract of zeroes. Even in low frequency groups, the quantization operation may also generate swarms of zeroes. Because the afterward bit-plane coding process is iterative, these zeroes would be repeatedly encoded into the output bit stream. This undoubtedly will cause severe loss of compression performance. One method disclosed in the present invention may help to exclude as many as possible zero coefficients from the bit-plane coding process, and hence significantly improve both compression and computation performance.

After quantization, each group of DCT coefficients, including those further decomposed by wavelet transform, is partitioned into squares. Then, test each square and identify it as either all-zero or not-all-zero. A square is all-zero, if all coefficients in it are zero; otherwise, it is not-all-zero. A value map is the data structure which signifies the all-zero or not-all-zero status for the squares in all frequency groups. Encode the value map by binary arithmetic coder. The scan pattern inside the value map may either be linear zigzag across all groups, or in the pattern of quadtree coding. The afterward bit-plane coding process only occurs to not-all-zero squares. Therefore, zero coefficients located in all-zero squares are excluded from the afterward iterative, costly bit-plane coding.

Scan Coefficients in Quaternary Reaching Pattern

The quaternary reaching pattern is similar to the quadtree coding in the bit-plane coding process. However, it only occurs to the not-all-zero squares. At each bit-plane, from the most significant bit-plane to the least significant one, the significance status of each not-all-zero square is tested and encoded. A square is significant at one bit-plane, if at least one coefficient in the square is significant at that bit-plane; otherwise, the square is insignificant. If a square is significant, it is divided into four smaller squares by evenly halving the width and height. Then, the significance status of the smaller squares are tested and encoded. This process recursively continues until individual coefficients are reached and encoded.

Coupled Bit-plane Coding

Since the bit-plane coding process is iterative, a large quantity of small coefficients, including zeroes, are repeatedly tested and encoded as insignificant until they are found significant in a low bit-plane. In order to accelerate the process and improve compression performance as well, in each scanning pass, all squares and coefficients are tested and encoded for the significance status at two consecutive bit-planes. So, the number of scanning passes may reduce about 50%. When a coefficient is found significant, one bit is output by arithmetic coder to signify at which bit-plane, the higher one or lower one, the coefficient begins to be significant. Afterward, the sign is encoded by arithmetic coder and then all the magnitude refinement bits are directly written into output bit stream.

A Lossy Image Compression System Based on Union of DCT and Wavelet

The encoding procedure of a lossy image compression system disclosed in the present invention comprises steps of: union of DCT and wavelet transform, quantization, value mapping, bit-plane coding.

First, decompose the image data, YCbCr form for color image or grey value for grey scale image, in 4×4 or 8×8 transform blocks using a fast DCT algorithm. Then, rearrange the DCT coefficients in 16 (4×4) or 64 (8×8) groups such that the coefficients in the same coordinate within all transform blocks are in one group, as described above for frequencywise rearrangement. Afterward, decompose the DC group, the group of coefficients at coordinate (0, 0), with wavelet transform, either 9-7 biorthogonal wavelet or 5-3 integer wavelet. It is optional for other groups to be decomposed by wavelet transform.

Secondly, quantize the transform coefficients using either visual weighting or uniform quantization. A quantization scheme with dead-zone is preferred.

Thirdly, inside each group, the coefficients are partitioned into squares in the size 4×4 or 8×8. Then, identify and encode each square as either all-zero or not-all-zero as described above about value map which is used to exclude zeroes from the bit-plane coding.

Finally, inside each not-all-zero square, the coefficients are encoded bit-plane by bit-plane, from the most significant bit-plane to the least significant one, in the quaternary reaching pattern as described above. However, in each scanning pass, all squares and coefficients are tested and encoded for the significance status at two consecutive bit-planes as described above as coupled bit-plane coding. When a coefficient is found significant, one bit is output by arithmetic coder to signify at which bit-plane, the higher one or lower one, the coefficient begins to be significant. Afterward, the sign is encoded by arithmetic coder and then all the magnitude refinement bits are directly written into output bit stream.

Table 1 shown below indicates experimental results of the above described lossy image compression system which is based on union of DCT and wavelet transform (UCW), in comparison with the currently most popular industrial standard JPEG which is based on 8×8 DCT. For fair comparison, the new system described above, called as UCW system herein, uses the same 8×8 DCT transform and quantization scheme as JPEG, and only the DC group is decomposed by (5, 3) integer wavelet transform, which means the decoded image data would be exactly the same in both systems. The sample images are Finger (512×512), Lena (512×512), Barbara (512×512). The experimental results are compared in file size (kilobytes) of encoded images at different quality levels.

TABLE 1
Comparison of lossy compression between JPEG and UCW.

| Quality Factor | | | | |
|---|---|---|---|---|
| 90 | 80 | 75 | 60 | 50 |

(a) Finger

| | | | | | |
|---|---|---|---|---|---|
| JPEG (kb) | 69.5 | 48.8 | 43.4 | 34.2 | 30.5 |
| UCW (kb) | 53.5 | 37.7 | 33.4 | 26.6 | 23.4 |

(b) Lena

| | | | | | |
|---|---|---|---|---|---|
| JPEG (kb) | 57.9 | 37.0 | 31.8 | 23.5 | 20.4 |
| UCW (kb) | 48.2 | 31.4 | 26.5 | 20.1 | 17.2 |

(c) Barbara

| | | | | | |
|---|---|---|---|---|---|
| JPEG (kb) | 72.1 | 49.6 | 43.8 | 33.9 | 30.0 |
| UCW (kb) | 61.6 | 41.3 | 36.7 | 27.1 | 24.8 |

Unnormalized Hadamard Transform in Lifting Steps

One apparatus for replacing DCT with a reversible 4×4 integer transform which is approximant to Hadamard transform is described herein. The 4×4 Hadamard matrix H4 may be written as H4=H2\textcircled{×}H2. It is easy to find that H2, the Harr transform, may be implemented in lifting steps which is also called as S-transform. However, the lifting form is an unnormalized form. So, an unnormalized H4 can be implemented by a 2-level S-transform. The followings are the lifting steps for the forward unnormalized H4 transform (x0, x1, x2, x3)→(y0, y1, y2, y3):

d0=x1−x0, c0=x0+└d0/2┘;

d1=x3−x2, c1=x2+└d1/2┘;

y2=c1−c0, y0=c0+└y2/2┘;

y3=d1−d0, y1=d0+└y3/2┘;

Encode Transform Coefficients in Two Layers by Three Steps

One method for lossless image compression described herein involves encoding the transform coefficients into two layers. The layers of encoded data are separated by a threshold for the magnitudes of coefficients. The transform may either be a union of a reversible DCT such as the unnormalized Hadamard transform described above and a reversible integer wavelet transform, or only a reversible integer wavelet transform itself such as the (5, 3) integer wavelet. Take a threshold T. The coefficients are encoded in two layers by three steps.

First, inside each frequency group (or subband if only wavelet transform), encode all coefficients that less than the threshold T in magnitude by arithmetic coder. The contexts for the arithmetic coder are decided by the two previously encoded coefficients, including the contexts for the sign bit and each bit of the magnitude. The scan pattern is one by one, column by column. After each coefficient is encoded, its storage is reset to zero.

Secondly, divide each frequency group (or subband) into squares. Then, build and encode the value map which signifies the all-zero squares from other not-all-zero squares, as in the above description of value map for lossy image compression.

Finally, inside each not-all-zero square, encode the coefficients bit-plane by bit-plane, from the most significant bit-plane to the least significant one, in the quaternary reaching pattern as described above for lossy image compression system. However, at each scanning pass, all squares and coefficients are tested and encode for the significance status at two consecutive bit-planes as described above for coupled bit-plane coding.

A Lossless Image Compression System Based on Union of Transforms

The general encoding procedure of a lossless image compression system based on union of transforms comprises the steps of: decomposing the image data using the union of unnormalized Hadamard transform and a reversible wavelet transform; encoding the coefficients in two layers by three steps as described above inside each group. First, decompose the image data using the unnormalized 4×4 Hadamard transform as described above. Then, rearrange the transform coefficients in to 16 (4×4) groups such that the coefficients in the same coordinate within all transform blocks are in one group, as described above for frequencywise rearrangement. Afterward, inside each group, further decompose the coefficients using the reversible (5, 3) integer wavelet transform. Finally, encode the transform coefficients in two layers by three steps as described above. Table 2 shown below indicates experimental results of the above described lossless image compression system, which is called as UCW herein, in comparison with the state-of-the-art industrial standard JPEG2000 which is based on (5, 3) integer wavelet transform. The lossless compression performance is compared in file size (kilobytes) of the encoded images.

TABLE 2
Comparison of lossless compression between JPEG2000 and UCW.

| Sample | Lena | Barbara | Bike | Woman |
|---|---|---|---|---|
| Image | (512 × 512) | (512 × 512) | (2048 × 2560) | (2048 × 2560) |
| JPEG2000 | 138 | 153 | 2898 | 2887 |
| (kb) | | | | |
| UCW (kb) | 112 | 137 | 2514 | 2458 |

The comparison of compression performance indicates the following conclusions:

(i) In lossy compression, the frequencywise rearrangement technique makes it feasible for DCT coefficients to be scanned and encoded in a 2-dimensional pattern and hence yields over 25% improvement in compression performance.

(ii) The further application of wavelet transform to DCT domain, especially to the DC frequency group, helps to decorrelate the statistical dependency between the local frequency contents of image signals.

(iii) Through frequencywise rearrangement of coefficients, DCT realizes a multifrequency analysis on image signals. Also, it makes a convenient framework for combining DCT and wavelet transform which improves lossless compression performance over 20% against the JPEG2000 which only uses wavelet transform.

The foregoing detailed description of the present invention has been presented by way of example only. It is contemplated that changes and modification may be made by one of ordinary skill of the art, to the materials and arrangement of elements of the present invention without departing from the scope of the invention. The followings are some examples:

(i) In lossy compression system, the 4×4 DCT or the integer approximant adopted in H.264 may be used in place of the 8×8 DCT;

(ii) In lossy compression system, besides the DC group, other groups, especially low frequency groups may also be further decomposed by wavelet transform;

(iii) In lossless compression system, other reversible DCT approximant may be used, besides the unnormalized Hadamard transform described herein;

(iv) In lossless image compression, the coefficient encoding algorithm may also be applied to wavelet coefficients, without union of DCT or its approximant.

What is claimed is:

1. A method for encoding or processing the coefficients of a block-based transform, comprising steps of: decomposing the original signal or image data using a block-based transform into blocks; rearranging the transform coefficients into a number of groups such that the number of groups is decided by the dimension of the transform block, the coefficients at the same coordinate within all blocks are rearranged into one group, a coefficient's coordinate within a group is the coordinate of the block which it comes from.

2. A method as claimed in claim 1, wherein the coefficients in one or more of the groups are further decomposed by a block-based transform or wavelet transform.

3. A method as claimed in claim 1, wherein the block-based transform may be discrete cosine transform (DCT) or its integer approximant or Hadamard transform.

4. A lossy image compression system, comprising: decomposing the image data into a number of frequency groups using a union of 4×4 or 8×8 DCT and wavelet transform; quantizing or visual weighting the coefficients; dividing each group into squares, then identifying and encoding each square as either all-zero or not-all-zero; inside each not-all-zero square, encoding the coefficients bit-plane by bit-plane in quaternary reaching pattern.

5. A lossless image compression system, comprising: decomposing the image data using a reversible wavelet transform or the union of a block-based, reversible transform and a reversible wavelet transform; taking a threshold T for the magnitude of coefficients, encoding the coefficients less than T in magnitude and then reset their storage to zero; dividing the coefficients into squares, then identifying and encoding each square as either all-zero or not-all-zero; inside each not-all-zero square, encoding the coefficients bit-plane by bit-plane in quaternary reaching pattern.
